(19) United States
(12) Patent Application Publication
(10) Pub. No.: US 2025/0374379 A1
(43) Pub. Date: Dec. 4, 2025

(54) WASHABLE ELECTRIC HEATING BLANKET CORE

(71) Applicant: QINGDAO VANKING LIVING CO.,LTD., Qingdao (CN)

(72) Inventors: Youping Du, Qingdao (CN); Zijie Zhu, Qingdao (CN); Ying Che, Qingdao (CN); Xiumei Wang, Qingdao (CN)

(21) Appl. No.: 18/676,854

(22) Filed: May 29, 2024

(51) Int. Cl. H05B 3/34; A47G 9/02; H05B 1/02

(52) U.S. Cl. CPC H05B 3/347; A47G 9/0215; A47G 9/0223; H05B 1/0272

(57) ABSTRACT

The present invention discloses a washable electric heating blanket core, and belongs to the field of electric blankets; wherein the washable electric heating blanket core comprises a blanket core and a controller connected to the blanket core by means of a wire, wherein the blanket core is woven from a yarn base material and a heating element, the heating element is composed of heating yarn, and the heating yarn is made of graphene yarn, carbon nanotube yarn, or silver-plated yarn; and positive conductive wires and negative conductive wires are arranged on an upper surface of the blanket core; when the heating yarn employs the graphene yarn or the carbon nanotube yarn, and when the heating yarn employs the silver-plated yarn, the antibacterial effect can be enhanced; wherein the electric heating blanket core can be used in different application scenarios such as blankets and carpets, and is widely used.

### TECHNICAL FIELD

The present invention belongs to the technical field of electric blankets, and particularly relates to a washable electric heating blanket core.

### BACKGROUND

Electric heating blanket cores are contact type electric heating tools, in which specially-made flexible cord type electric heating elements with the insulation properties meeting standards are woven or sewn in a coiled shape into the blanket cores and emit heat when being electrified.

Some existing heating elements of the electric heating blanket cores are most electric heating wires made of metallic materials such as copper, aluminum, iron and nicochrome, resulting in local overheating and even short-circuiting easily after folding, which affects normal usage.

### SUMMARY

The present invention aims to provide a washable electric heating blanket core, so as to solve the problems put forward in the background art.

In order to achieve the above purpose, the present invention provides the following technical solution: the washable electric heating blanket core comprises a blanket core and a controller connected to the blanket core by means of a wire, wherein the blanket core is woven from a yarn base material and a heating element, and the heating element is composed of heating yarn; and

positive conductive wires and negative conductive wires are arranged on an upper surface of the blanket core, flame-retardant layers are arranged on the upper surface and a lower surface of the blanket core, moisture-proof layers are arranged on outer surfaces of the flame-retardant layers, and waterproof layers are arranged on outer surfaces of the moisture-proof layers.

As a preferred embodiment, a protective cover is rotationally connected to an outer surface of the controller by means of hinges.

As a preferred embodiment, the flame-retardant layer is composed of a fireproof basalt fiber cloth.

As a preferred embodiment, a magnet is fixedly installed inside the protective cover, and an iron sheet corresponding to the magnet is fixedly installed inside the controller.

As a preferred embodiment, the waterproof layer is composed of a waterproof nylon cloth.

As a preferred embodiment, a waterproof silicone insulation layer is arranged on each of outer surfaces of the positive conductive wires and the negative conductive wires.

As a preferred embodiment, the heating yarn is made of graphene yarn, carbon nanotube yarn, or silver-plated yarn.

Compared with the prior art, the present invention has the beneficial effects as follows:

with regard to the washable electric heating blanket core, during the process of producing the blanket core and weaving a cloth, the heating element composed of the heating yarn can be directly woven into the yarn base material, so that there is no difference between the blanket core and a common fabric, and the blanket core is soft, is skin-friendly and can be folded at will; when the heating yarn employs the graphene yarn or the carbon nanotube yarn, the maximum heating temperature of the graphene or carbon nanotube yarn does not exceed 60°C, and the local overheating phenomenon can be avoided due to uniform heating, thereby achieving long-term safe usage; and the graphene or carbon nanotube yarn itself has a far-infrared function, is free from electromagnetic radiation, and is beneficial to human bodies; and when the heating yarn employs the silver-plated yarn, the antibacterial effect can be enhanced; the electric heating blanket core can be used in different application scenarios such as blankets and carpets, and is widely used;

with regard to the washable electric heating blanket core, by means of the waterproof silicone insulation layers arranged on the outer surfaces of the positive conductive wires and the negative conductive wires, and by means of the waterproof layers, the blanket core has certain waterproof properties; and

with regard to the washable electric heating blanket core, by means of the design of the controller, the protective cover, the magnet and the iron sheet, during the process of laying the blanket core, the situation that a child accidentally touches a switch of the controller can be reduced, and the usage safety of the blanket core can be increased.

### BRIEF DESCRIPTION OF DRAWINGS

FIG. 1 is a structural schematic diagram of a blanket core and a controller in the present invention;

FIG. 2 is a structural schematic diagram of the controller in the present invention;

FIG. 3 is a front sectional structural schematic diagram of the present invention; and

FIG. 4 is a structural schematic diagram of a yarn base material and a heating element in the present invention.

In the drawings: 1. blanket core; 101. yarn base material; 102. heating element; 2. controller; 3. positive conductive wire; 4. negative conductive wire; 6. flame-retardant layer; 7. moisture-proof layer; 8. waterproof layer; 9. protective cover; 10. magnet; and 11. iron sheet.

### DETAILED DESCRIPTION OF THE EMBODIMENTS

The present invention is further described below in conjunction with embodiments.

The embodiments below are intended to illustrate the present invention, but are not intended to limit the scope of protection of the present invention. Conditions in the embodiments can be further adjusted according to specific conditions, and simple improvements of the method in the present invention on the premise of the concept of the present invention fall within the scope of protection of the present invention.

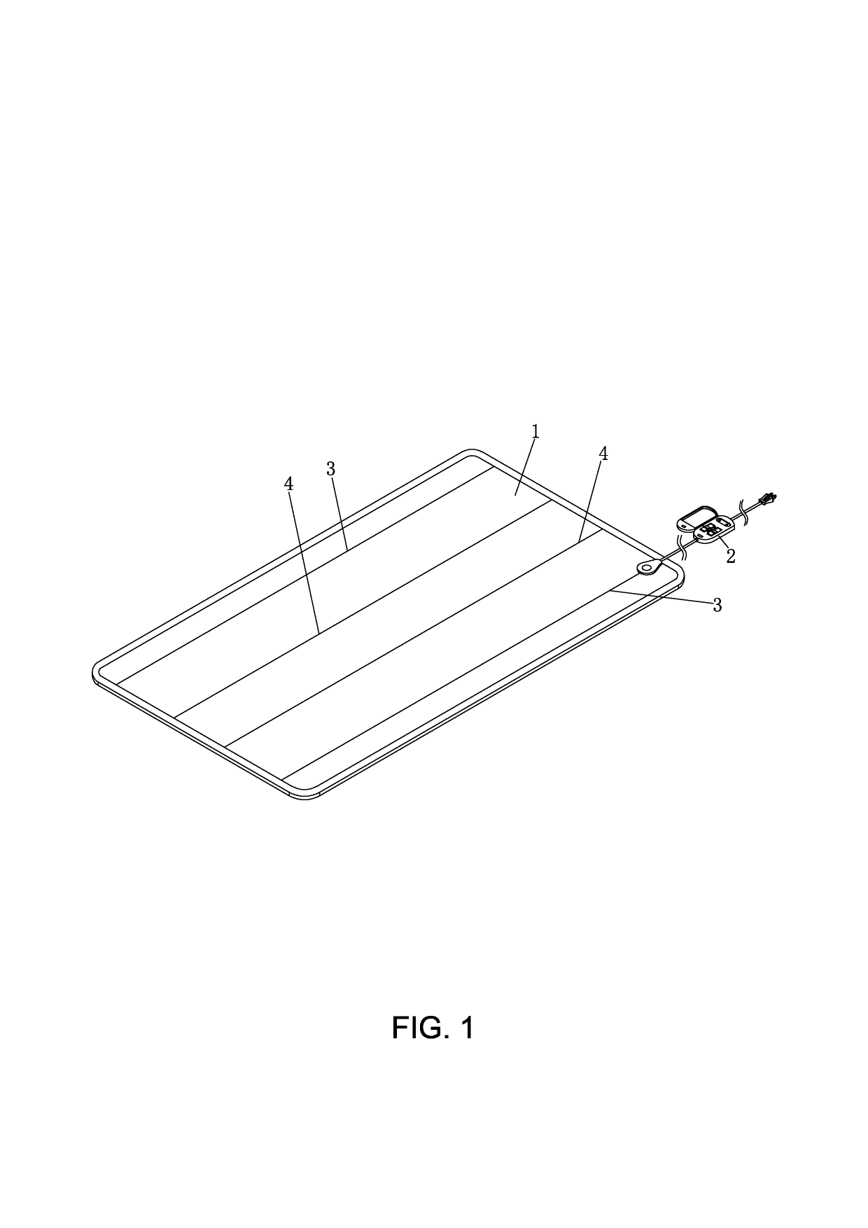

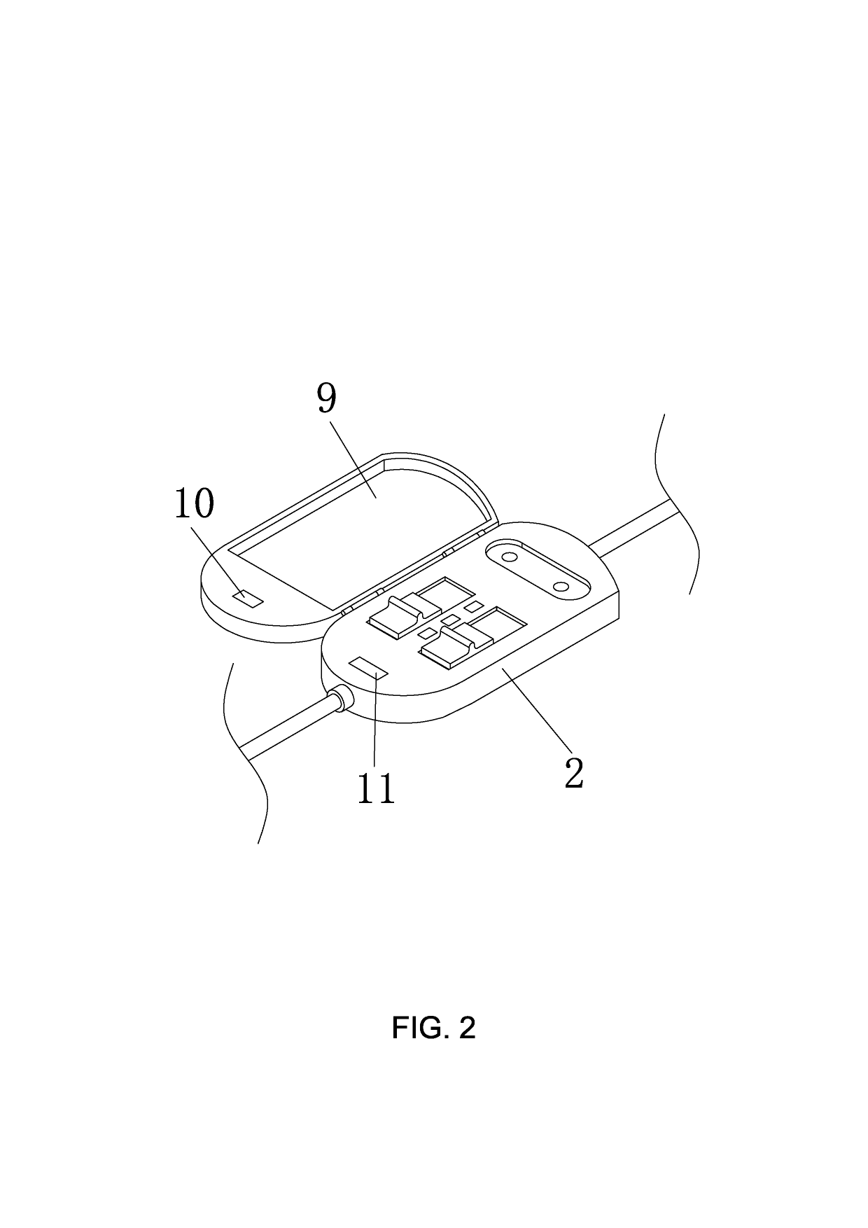

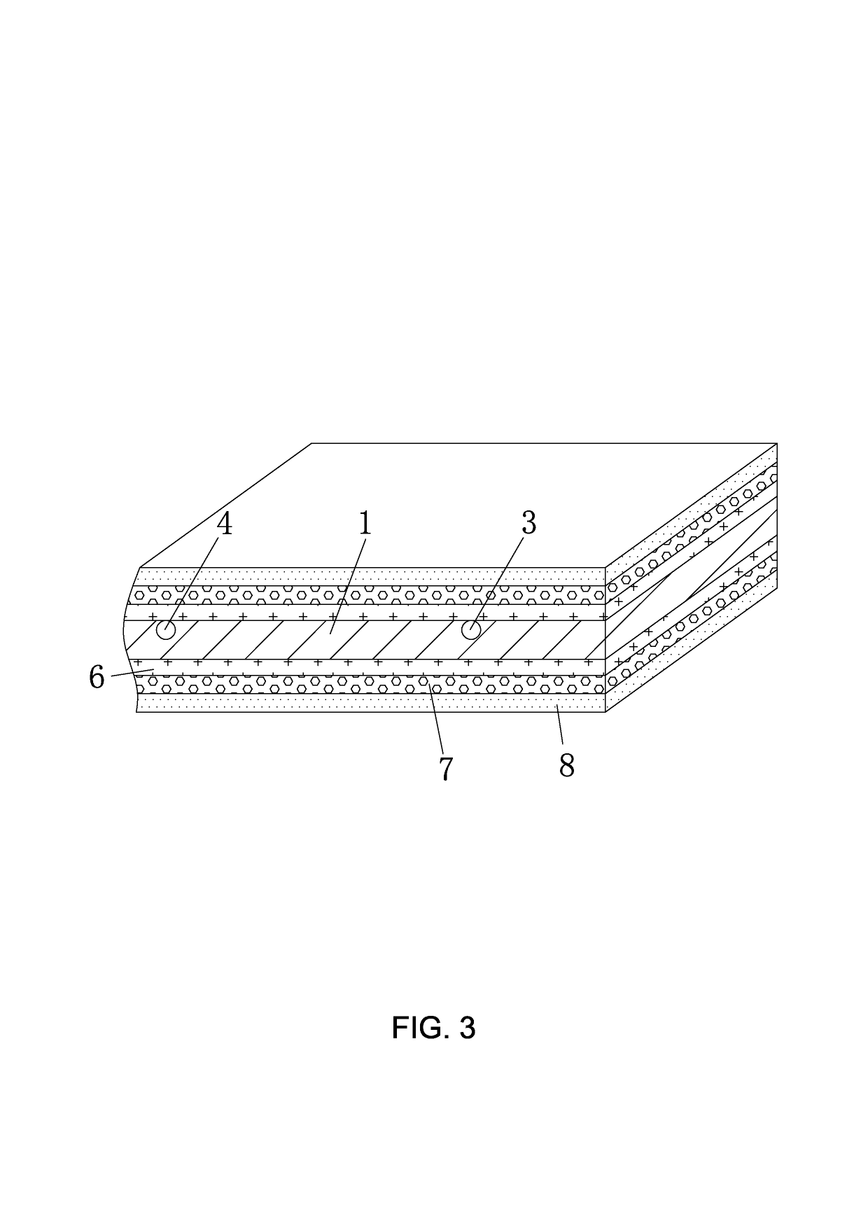

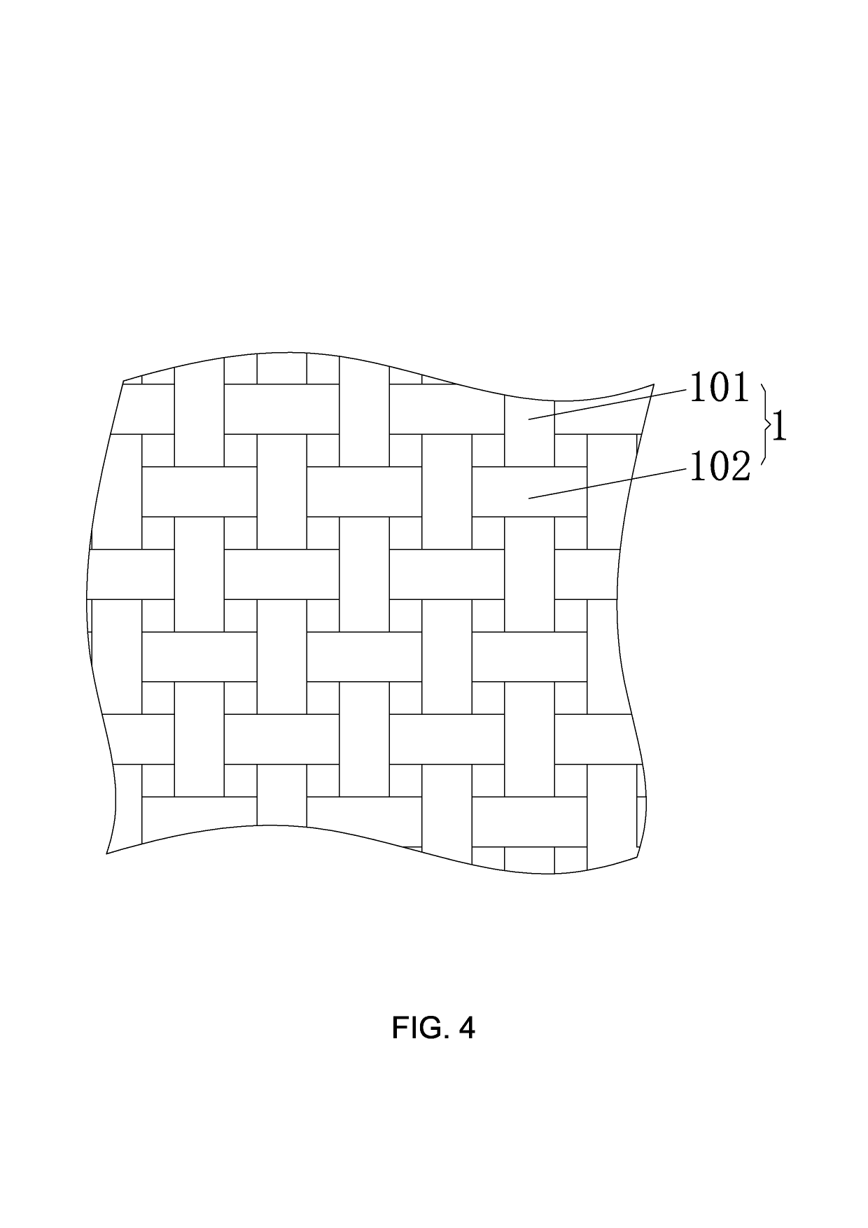

Reference is made to FIGS. 1-4. The present invention provides a washable electric heating blanket core, comprising a blanket core 1 and a controller 2 connected to the blanket core 1 by means of a wire, wherein a protective cover 9 is rotationally connected to an outer surface of the controller 2 by means of hinges. The protective cover 9 can protect the controller 2, thereby reducing the situation that a child accidentally touches a switch of the controller 2. A magnet 10 is fixedly installed inside the protective cover 9, and an iron sheet 11 corresponding to the magnet 10 is fixedly installed inside the controller 2. By means of the magnet 10 and the iron sheet 11, a user can conveniently open the protective cover 9 to operate the switch of the controller 2.

Further, the blanket core 1 is woven from a yarn base material 101 and a heating element 102, the heating element 102 is composed of heating yarn, and the heating yarn is made of graphene yarn, carbon nanotube yarn, or silver-plated yarn; when the heating yarn employs the graphene yarn or the carbon nanotube yarn, the maximum heating temperature of the graphene or carbon nanotube yarn does not exceed 60°C, and the local overheating phenomenon can be avoided due to uniform heating, thereby achieving long-term safe usage, and when the heating yarn employs the silver-plated yarn, the antibacterial effect can be enhanced. The yarn base material 101 may be common textile yarn such as cotton, viscose, Lyocell, nylon and polyester. Positive conductive wires 3 and negative conductive wires 4 are arranged on an upper surface of the blanket core 1, a waterproof silicone insulation layer is arranged on each of outer surfaces of the positive conductive wires 3 and the negative conductive wires 4, and the waterproof silicone insulation layers can increase the waterproof properties of the positive conductive wires 3 and the negative conductive wires 4.

Further, flame-retardant layers 6 are arranged on the upper surface and a lower surface of the blanket core 1, and the flame-retardant layer 6 is composed of a fireproof basalt fiber cloth. The fireproof basalt fiber cloths can increase the fireproof and flame-retardant properties of the blanket core 1, thereby increasing the usage safety of the blanket core 1.

Further, moisture-proof layers 7 are arranged on outer surfaces of the flame-retardant layers 6, and waterproof layers 8 are arranged on outer surfaces of the moisture-proof layers 7. The waterproof layer 8 is composed of a waterproof nylon cloth, which can increase the waterproof properties of the blanket core 1.

The working principle and usage process of the present invention are as follows: during the process of producing the blanket core 1 and weaving a cloth, the heating element 102 composed of the heating yarn can be directly woven into the yarn base material 101, so that there is no difference between the blanket core 1 and a common fabric, and the blanket core is soft, is skin-friendly and can be folded at will; and when the heating yarn employs the graphene yarn or the carbon nanotube yarn, the maximum heating temperature of the graphene or carbon nanotube yarn does not exceed 60°C, and the local overheating phenomenon can be avoided due to uniform heating, thereby achieving long-term safe usage; and the graphene or carbon nanotube yarn itself has a far-infrared function, is free from electromagnetic radiation, and is beneficial to human bodies; and when the heating yarn employs the silver-plated yarn, the antibacterial effect can be enhanced; and the electric heating blanket core can be used in different application scenarios such as blankets and carpets, and is widely used.

Although the embodiments of the present invention are shown and described, it is understandable that those of ordinary skill in the art can make various changes, amendments, substitutions and modifications to these embodiments without departing from the principle and the spirit of the present invention, and the scope of the present invention is defined by the appended claims and equivalents thereof.

What is claimed is:

1. A washable electric heating blanket core, comprising a blanket core (1) and a controller (2) connected to the blanket core (1) by means of a wire, wherein the blanket core (1) is woven from a yarn base material (101) and a heating element (102), and the heating element (102) is composed of heating yarn; and
positive conductive wires (3) and negative conductive wires (4) are arranged on an upper surface of the blanket core (1), flame-retardant layers (6) are arranged on the upper surface and a lower surface of the blanket core (1), moisture-proof layers (7) are arranged on outer surfaces of the flame-retardant layers (6), and waterproof layers (8) are arranged on outer surfaces of the moisture-proof layers (7).

2. The washable electric heating blanket core according to claim 1, wherein a protective cover (9) is rotationally connected to an outer surface of the controller (2) by means of hinges.

3. The washable electric heating blanket core according to claim 1, wherein the flame-retardant layer (6) is composed of a fireproof basalt fiber cloth.

4. The washable electric heating blanket core according to claim 2, wherein a magnet (10) is fixedly installed inside the protective cover (9), and an iron sheet (11) corresponding to the magnet (10) is fixedly installed inside the controller (2).

5. The washable electric heating blanket core according to claim 1, wherein the waterproof layer (8) is composed of a waterproof nylon cloth.

6. The washable electric heating blanket core according to claim 1, wherein a waterproof silicone insulation layer is arranged on each of outer surfaces of the positive conductive wires (3) and the negative conductive wires (4).

7. The washable electric heating blanket core according to claim 1, wherein the heating yarn is made of graphene yarn, carbon nanotube yarn, or silver-plated yarn.
